(19) United States
(12) Patent Application Publication
(10) Pub. No.: US 2007/0008448 A1
(43) Pub. Date: Jan. 11, 2007

(54) ACTIVE MATRIX SUBSTRATE

(76) Inventor: Han-Chung Lai, Taoyuan Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/163,277

(22) Filed: Oct. 12, 2005

(30) Foreign Application Priority Data
Jul. 7, 2005 (TW) 94122971

(51) Int. Cl. G02F 1/136

(52) U.S. Cl. 349/44

(57) ABSTRACT

An active matrix substrate is provided. The active matrix substrate includes a substrate, a plurality of scan lines, a plurality of data lines, a plurality of pixel units, and a light leakage-inhibiting layer. The scan lines, the data lines, the pixel units, and the light leakage-inhibiting layer are disposed on the substrate. The pixel units are electrically connected to corresponding scan lines and data lines. Furthermore, each pixel unit includes an active device and a pixel electrode electrically connected to the active device. Moreover, the light leakage-inhibiting layer is disposed next to the data lines. With the aforementioned active matrix substrate, a liquid crystal display is prevented from having moveable mura.

### CROSS-REFERENCE TO RELATED APPLICATION

This application claims the priority benefit of Taiwan application serial no. 9 94122971, filed on Jul. 7, 2005. All disclosure of the Taiwan application is incorporated herein by reference.

### BACKGROUND OF THE INVENTION

1. Field of the Invention

The present invention relates to an active matrix substrate. More particularly, the present invention relates to an active matrix substrate that improves the movable mura phenomenon in a liquid crystal display.

2. Description of the Related Art

To match our modern lifestyle, lighter and slimmer video and imaging devices have been developed. Although the conventional cathode ray tube (CRT) display still has some advantages, the electron gun structure inside the CRT renders it bulky and occupies considerable space. Furthermore, hazardous radiation is often outputted when images are displayed on the CRT screen with the possibility of hurting the eyes. With breakthroughs in photo-electronic technologies and newer methods of fabricating semiconductor device, flat panel displays such as liquid crystal display have become one of the mainstream display products for many types of electronic appliances.

FIG. 1A is a top view of a conventional thin film transistor array substrate. FIGS. 1B, 1C, and 1D are the respective cross-sectional views along line a-b, line c-d, and line e-f of FIG. 1A. As shown in FIGS. 1A through 1D, the conventional thin film transistor array substrate 100 comprises a glass substrate 110, a plurality of data lines 120, a plurality of scan lines 130, and a plurality of pixel units 140. The pixel units 140 are electrically connected to the corresponding data line 120 and scan line 130. Furthermore, each pixel unit 140 includes a thin film transistor 142 and a transparent conductive electrode 144 (for example, made from indium-tin oxide (ITO) material).

FIG. 2 is a schematic cross-sectional view of a conventional color filter. As shown in FIG. 2, the conventional color filter 200 includes a glass substrate 210, a black matrix 220, a color filtering thin film array 230, a common electrode 240, and a plurality of spacers 250. The black matrix 220 is disposed on the glass substrate 210 for preventing the leakage of light. The color filtering thin film array 230 is disposed on the glass substrate 210 to cover the black matrix 220. The common electrode 240 is disposed on the color filtering thin film array 230. In addition, the spacers 250 are disposed on the common electrode 240 for maintaining a cell gap.

FIGS. 3A through 3C are schematic cross-sectional views of a conventional liquid crystal display panel. First, the conventional liquid crystal display panel 300 includes the aforementioned thin film transistor array substrate 100, the color filter 200, and a liquid crystal layer 310 as shown in FIG. 3A. The liquid crystal layer 310 is disposed between the thin film transistor array substrate 100 and the color filter 200. Furthermore, the spacer 250 on the color filter 200 is in contact with the thin film transistor array substrate 100. Through the disposition of the spacer 250, a fixed chip cavity distance is sustained between the thin film transistor array substrate 100 and the color filtering film 200.

As shown in FIG. 3B, the black matrix 220 can effectively block any light leaking from the area between the pixel electrode 144 and the data line 120 when the liquid crystal display panel 300 displays a picture. Hence, the light does not leak out from the liquid crystal display panel 300 so that the quality of the displayed images is improved.

As shown in FIG. 3C, the color filter 200 shifts to an offset position if the user applies an external force on the color filter 200 of the liquid crystal display panel 300. When this happens, the black matrix 220 on the color filter 200 is also offset so that a portion of the light shining on the area between the pixel electrode 144 and the data lines 120 is no longer blocked by the black matrix 220. As a result, some of the light leaks out from the liquid crystal panel 300. Therefore, if the user's hands contact the surface of the liquid crystal display panel 300, the chance for light leakage from a localized region of the liquid crystal display panel 300 is increased. Ultimately, the phenomenon of having a moveable mura appears.

### SUMMARY OF THE INVENTION

Accordingly, at least one objective of the present invention is to provide an active matrix substrate capable of improving the occurrence of moveable mura on a liquid crystal display.

To achieve these and other advantages in accordance with the purpose of the invention, as embodied and broadly described herein, the invention provides an active matrix substrate. The active matrix substrate includes a substrate, a plurality of scan lines, a plurality of data lines, a plurality of pixel units, and a light leakage-inhibiting layer. The scan lines, the data lines, the pixel units and the light leakage-inhibiting layer are disposed on the substrate. The pixel units are electrically connected to the corresponding scan lines and data lines. Furthermore, each pixel unit includes an active device and a pixel electrode electrically connected to the active device. Moreover, the light leakage-inhibiting layer is disposed next to the data lines.

According to one preferred embodiment of the present invention, the light leakage-inhibiting layer of the active matrix substrate is disposed between the pixel electrode and the data line and is overlapped with pixel electrode.

According to one preferred embodiment of the present invention, the light leakage-inhibiting layer is disposed beneath the data line and is overlapped with pixel electrode.

According to one preferred embodiment of the present invention, the light leakage-inhibiting layer of the active matrix substrate further includes an amorphous silicon layer.

Accordingly, compared with the conventional technique, the active matrix substrate in the present invention has a light leakage-inhibiting layer for reducing the intensity of light leakage from the gap between the pixel electrode and the data line. Consequently, the active matrix substrate significantly improves on the phenomenon of having a moveable mura in the liquid crystal display.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a top view of a conventional thin film transistor array substrate.

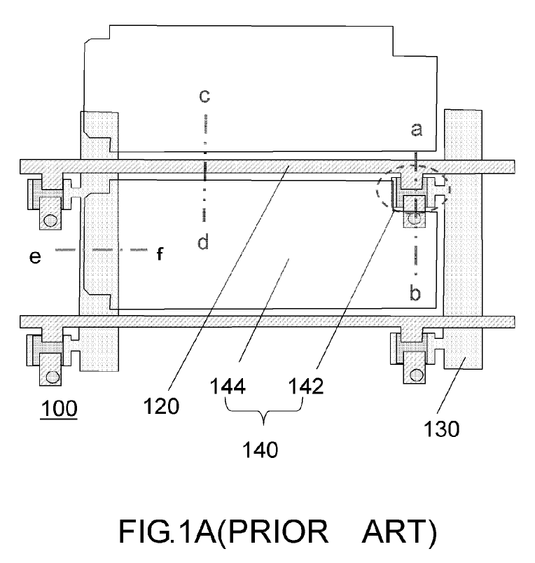

FIGS. 1B, 1C, and 1D are the respective cross-sectional views along line a-b, line c-d, and line e-f of FIG. 1A.

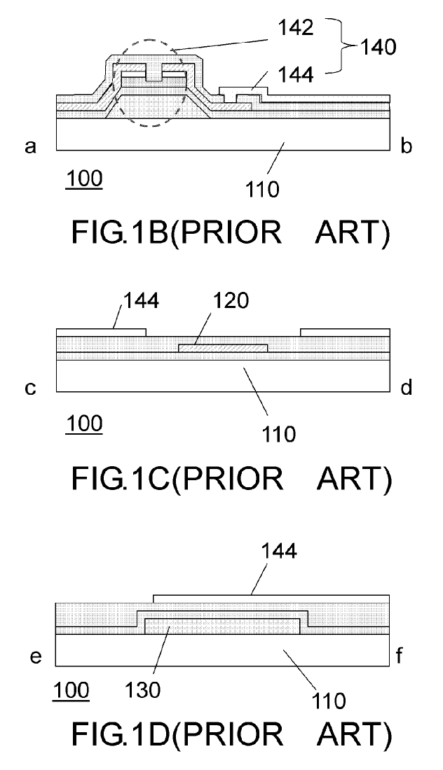

FIG. 2 is a schematic cross-sectional view of a conventional color filter.

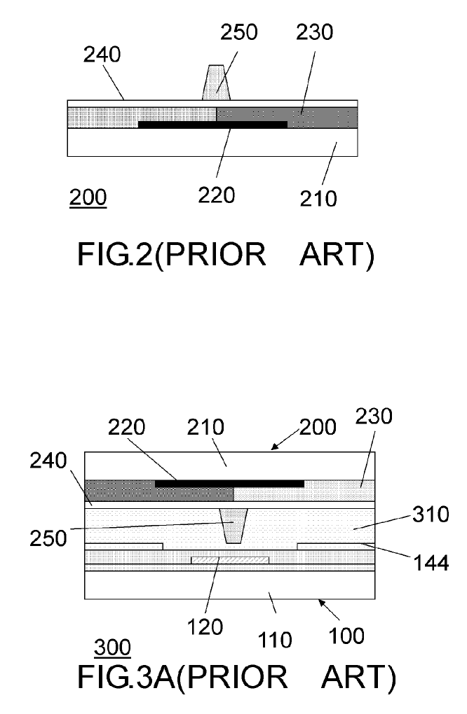

FIGS. 3A through 3C are schematic cross-sectional views of a conventional liquid crystal display panel.

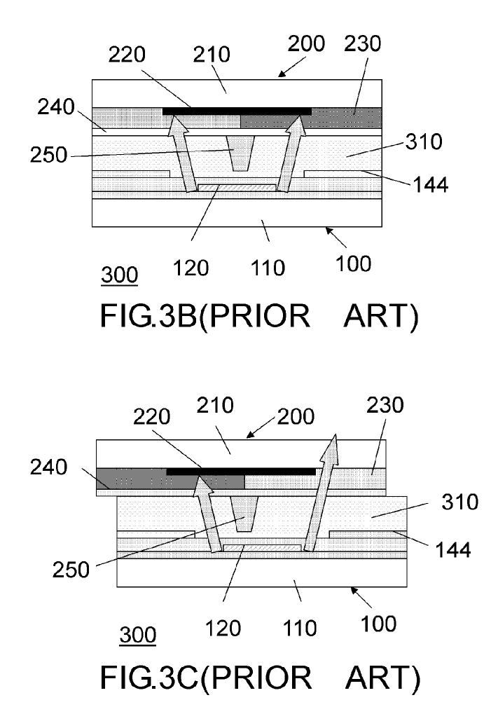

FIG. 4A is a top view of an active matrix substrate according to a first embodiment of the present invention.

FIGS. 4B, 4C and 4D are the respective cross-sectional views along line a-b, line c-d, and line e-f of FIG. 4A.

FIGS. 5A and 5B are schematic cross-sectional views of a liquid crystal display panel according to a second embodiment of the present invention.

FIG. 6A is a top view of an active matrix substrate according to a second embodiment of the present invention.

FIGS. 6B, 6C, and 6D are the respective cross-sectional views along line a-b, line c-d, and line e-f of FIG. 6A.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

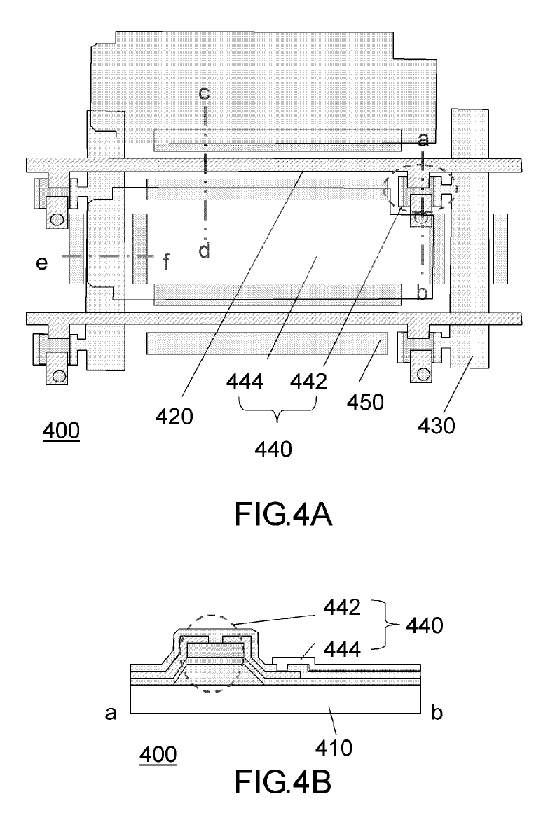

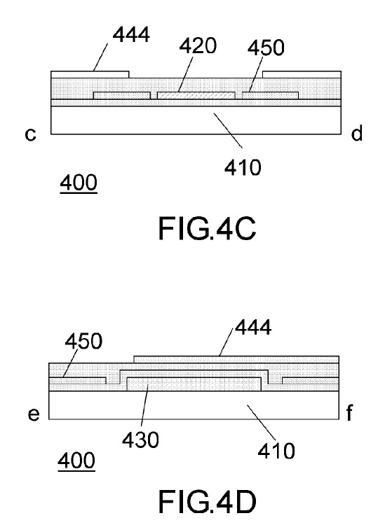

FIG. 4A is a top view of an active matrix substrate according to a first embodiment of the present invention. FIGS. 4B, 4C, and 4D are the respective cross-sectional views along line a-b, line c-d, and line e-f of FIG. 4A. As shown in FIGS. 4A through 4D, the active matrix substrate 400 includes a substrate 410, a plurality of data lines 420, a plurality of scan lines 430, a plurality of pixel units 440, and a light leakage-inhibiting layer 450. The data lines 420, the scan lines 430, the pixel units 440, and the light leakage-inhibiting layer 450 are disposed on the substrate 410.

In the present embodiment, the substrate 410 is a glass substrate or another transparent substrate, for example. The data lines 420 are chromium lines or lines fabricated using other suitable conductive materials, for example. The scan lines 430 are aluminum lines or lines fabricated using other suitable conductive materials, for example. More specifically, the data lines 420 and the scan lines 430 are oriented perpendicular to each other so that a plurality of pixel regions (not shown) are defined. The pixel units 440 are disposed inside the respective pixel regions.

As shown in FIG. 4A, the pixel unit 440 is electrically connected to a corresponding data line 420 and scan line 430. Furthermore, the pixel unit 440 includes an active device 442 and a pixel electrode 444. In the present embodiment, the active device 442 is a thin film transistor or other three-terminal switching device; and the pixel electrode 444 is a transmissive electrode, a reflective electrode, or a transflective electrode, for example. The pixel electrode 444 can be fabricated using indium-zinc oxide (IZO), a metal, or other conductive material, for example.

As shown in FIGS. 4A, 4C, and 4D, the light leakage-inhibiting layer 450 in the present embodiment is disposed next to the two respective sides of the data line 420. Furthermore, a part of the light leakage-inhibiting layer 450 overlaps with part of the overlaying pixel electrode 444. The purpose of setting up the light leakage-inhibiting layer 450 is to attenuate the intensity of the light leaking out from the gap between the pixel electrode 444 and the data line 420. In one preferred embodiment of the present invention, the light leakage-inhibiting layer 450 is an amorphous silicon layer, for example. Because an amorphous silicon layer is not completely opaque, the moveable mura issue is effectively improved.

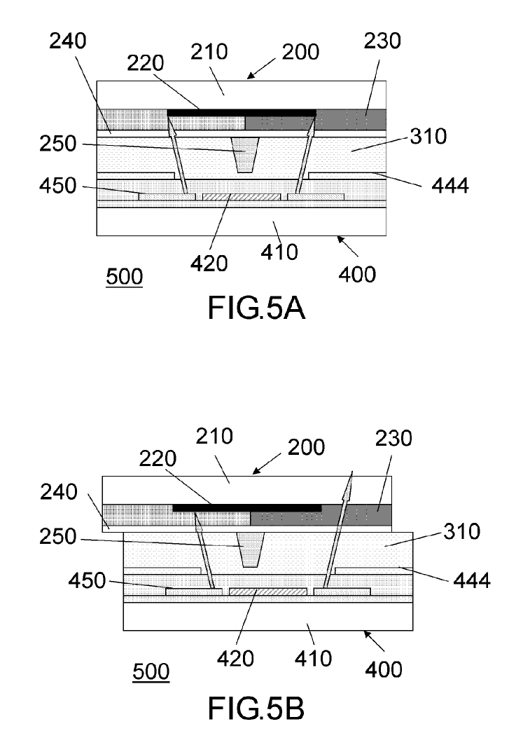

FIGS. 5A and 5B are schematic cross-sectional views of a liquid crystal display panel according to a second embodiment of the present invention. First, as shown in FIG. 5A, the liquid crystal display panel 500 in the present embodiment includes the aforementioned active matrix substrate 400, a color filter 200, and a liquid crystal layer 310. The liquid crystal layer 310 is disposed between the thin film transistor array substrate 400 and the color filter 200. Furthermore, the spacer 250 above the color filter 200 is in contact with the thin film transistor matrix substrate 400. Through the spacer 250, a fixed chip cavity is sustained between the thin film transistor matrix substrate 400 and the color filter 200. Compared with a conventional thin film transistor matrix substrate 100, the active matrix substrate 400 in the present embodiment has an additional light leakage-inhibiting layer 450. Meanwhile, various components below the black matrix serve a function similar to that provided by a conventional thin film transistor matrix substrate.

FIG. 5B shows the leakage of light after the color filter of the liquid crystal display panel shown in FIG. 5A is forced to shift by a distance. In FIG. 5B, if the user applies an external force to the color filter 200 of the liquid crystal display panel 500, the color filter 200 is forced to shift by a definite distance. In this circumstance, the black matrix 220 above the color filter 200 is also forced to move a distance. Because the light leakage-inhibiting layer 450 limits the intensity of light emitted through the gap between the pixel electrode 444 and the data line 420, a liquid crystal display having the active matrix substrate 400 according to the present invention can easily avoid the moveable mura issue.

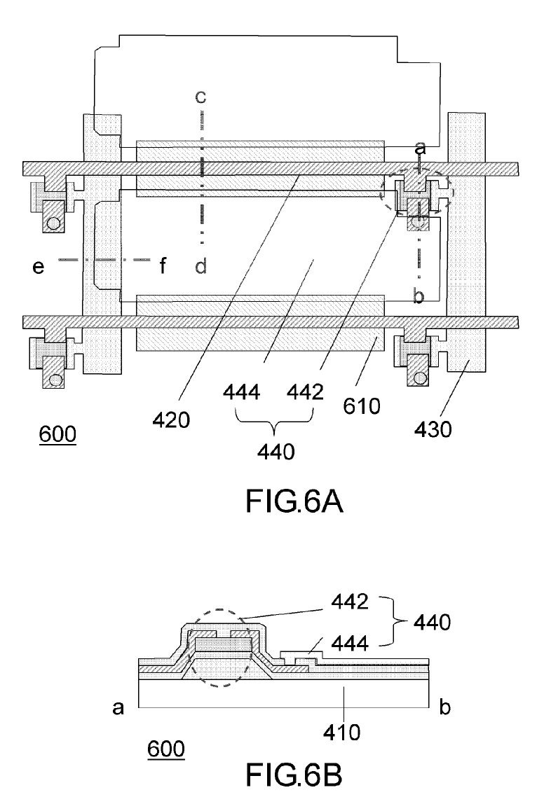

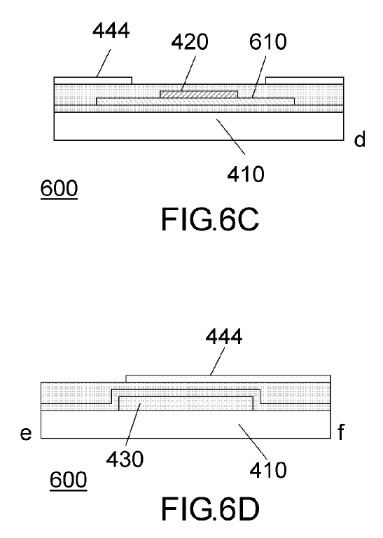

FIG. 6A is a top view of an active matrix substrate according to a second embodiment of the present invention. FIGS. 6B, 6C, and 6D are the respective cross-sectional views along line a-b, line c-d, and line e-f of FIG. 6A. As shown in FIGS. 6A through 6D, the active matrix substrate 600 in the present embodiment is very similar to the active matrix substrate 400 in the first embodiment. The main difference between the two is that the light leakage-inhibiting layer 610 of the active matrix substrate 600 extends from the area below the data line 420 toward the two sides of the data line 420. Moreover, part of the light leakage-inhibiting layer 450 overlaps with part of the pixel electrode 444 above. Therefore, the light leakage-inhibiting layer 610 in the present embodiment effectively prevents the moveable mura phenomenon from appearing on the two sides of the data line 420.

In summary, the major advantages of the active matrix substrate in the present invention at least includes the following.

1. A light leakage-inhibiting layer is disposed in the active matrix substrate in the present invention to reduce the intensity of the light leaking from the gap between the pixel electrode and the data line. Thus, the issue of having moveable mura in the liquid crystal display is improved.

2. The method of fabricating the active matrix substrate in the present invention is compatible with the existing techniques. In other words, only one patterning photomask needs to be modified, and there is no need to procure additional equipment.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An active matrix substrate, comprising:
a substrate;
a plurality of scan lines disposed on the substrate;
a plurality of data lines disposed on the substrate;
a plurality of pixel units disposed on the substrate and electrically connected to a corresponding scan line and a data line, wherein each pixel unit has an active unit and a pixel electrode connected to the active device; and
a light leakage-inhibiting layer disposed on the substrate, wherein the light leakage-inhibiting layer is disposed adjacent to the respective sides of data line.

2. The active matrix substrate of claim 1, wherein the light leakage-inhibiting layer is disposed between the pixel electrode and the data line, and is overlapped with the pixel electrode.

3. The active matrix substrate of claim 2, wherein the light leakage-inhibiting layer is disposed beneath the data line, and is overlapped with the pixel electrode.

4. The active matrix substrate of claim 1, wherein the light leakage-inhibiting layer includes an amorphous silicon layer.
